(19) United States
(12) Patent Application Publication
(10) Pub. No.: US 2017/0294792 A1
(43) Pub. Date: Oct. 12, 2017

(54) SYSTEMS AND METHODS FOR LIMITING INRUSH CURRENT IN CHARGING DEVICES

(71) Applicant: Ergotron, Inc, St. Paul, MN (US)

(72) Inventor: William Dale Tischer, Shoreview, MN (US)

(21) Appl. No.: 15/512,461

(22) PCT Filed: Sep. 18, 2015
(86) PCT No.: PCT/US2015/050943

§ 371 Date: Mar. 17, 2017

Related U.S. Application Data
(60) Provisional application No. 62/052,733, filed on Sep. 19, 2014.

(51) Int. Cl. H02J 7/00

(52) U.S. Cl. CPC H02J 7/0029; H02J 7/0021; H02J 7/007; H02J 2007/0039

(57) ABSTRACT

A charging device configured to charge a plurality of electronic devices includes an electrical load management system configured to limit an inrush current. The system includes a plurality of switches coupled between a common alternating current power source and a plurality of electrical loads, each of the plurality of switches coupled to a respective one of the plurality of electrical loads, wherein each of the electrical loads includes one or more of the plurality of electronic devices, and a controller coupled to the plurality of switches, the controller configured to sequentially turn on each of the plurality of switches and apply power from the common power source to each of the plurality of electrical loads during non-overlapping time periods to limit the inrush current.

### CLAIM OF PRIORITY

This application claims the benefit of priority of U.S. Provisional Patent Application No. 62/052,733, titled “SYSTEMS AND METHODS FOR LIMITING INRUSH CURRENT IN CHARGING DEVICES,” to William D. Tischer and filed on Sep. 19, 2014, which is incorporated by reference herein in its entirety.

### TECHNICAL FIELD

This disclosure generally relates to the management of electrical loads and, more particularly, to limiting inrush current.

### BACKGROUND

Charging carts, desktop chargers, and wall-mount chargers (collectively “charging devices”) are prevalent today in order for the large numbers of tablets, notebooks, and other portable electronic devices used in schools, offices, factories, etc. to be charged overnight or between work shifts. These charging devices continue to increase in size and capacity in order to charge more portable electronic devices. Due to the nature of the portable electronic device power supplies, large inrush currents can occur if not controlled by the charging device when plugged into the wall outlet or when the on/off switch is enabled.

High inrush currents in portable electronic devices can be caused by the switch-mode power supply input capacitance. These power supplies have large capacitors at the front end of the circuitry where alternating current (“AC”) is converted to direct current (“DC”) for subsequent switching to higher frequencies. At the time voltage is applied to the power supply, the capacitor acts like a short-circuit where the current is limited primarily by the resistance of the wire and the resistance of any connectors between the source of the input AC voltage and the capacitor in the power supply. If not controlled, inrush current can result in nuisance tripping of wall breakers, damage to the cart power cord contacts (welding), and damage to the wall-outlet contacts (welding), for example.

Designers of portable electronic device power supplies can limit the inrush current in the individual power supplies but when grouped together in charging devices where 40 or more can be installed, these inrush currents can be on the order of many thousands of amps. Individually the currents are typically 40-amps at 250 VAC and have duration of less than a half-cycle (approximately 8 to 10-ms depending on 60 Hz or 50 Hz AC input frequency). The lower the AC input voltage to the device, the lower the inrush current so countries such as the US have less of a concern than other countries such as Germany or China.

There are two common ways to mitigate inrush current: 1) Negative Temperature Coefficient (NTC) devices and 2) zero-crossing detection circuitry.

NTC devices have a high resistance when cold and low resistance when hot. When the device is turned on, the inrush is limited by the high resistance of the NTC device. After the inrush, the NTC is warm so the resistance is low and the power supply functions normally. One disadvantage of NTCs is their physical size and the power dissipation required, especially in large charging carts where 40 notebook computers could require control of inrush currents exceeding 3200 amps.

With zero-crossing detection, the power supplies are not allowed to turn on until the voltage is essentially zero. So, as the voltage rises according to the sine output provided from the power source, the current rises proportionately at a much lower initial rate than if the power supply was connected at the time of peak voltage from the power source. One disadvantage of zero-crossing detection is the extra hardware and firmware that can be needed to control the turn-on point of electro-mechanical or solid-state relays providing connection between the source voltage and the portable electronic device power supply. This extra circuitry can add cost to the product and ultimately more cost to the consumer. Additionally, more parts can mean less reliability and potentially more downtime to the user.

### SUMMARY

This disclosure describes various techniques for controlling inrush current in charging devices, e.g., charging carts, desktop chargers, and wall-mount chargers, that are configured to charge a plurality of electronic devices, e.g., laptop computers, tablet computers, and the like.

This Summary is an overview of some of the teachings of the present application and not intended to be an exclusive or exhaustive treatment of the present subject matter. Further details about the present subject matter are found in the detailed description and appended claims. Other aspects of the disclosure will be apparent to persons skilled in the art upon reading and understanding the following detailed description and viewing the drawings that form a part thereof, each of which are not to be taken in a limiting sense. The scope of the present disclosure is defined by the appended claims and their legal equivalents.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of system that can be used to control inrush current in a charging device configured to charge a plurality of electronic devices, in accordance with this disclosure.

FIG. 2 is a flow diagram illustrating an example of a method of controlling inrush current in a charging device configured to charge a plurality of electronic devices, in accordance with this disclosure.

### DETAILED DESCRIPTION

This disclosure describes techniques for controlling inrush current in charging devices, e.g., charging carts, desktop chargers, and wall-mount chargers, that are configured to charge a plurality of electronic devices, e.g., laptop computers, tablet computers, and the like. For example, this disclosure describes limiting the number of devices that are initially connected to the source voltage so that even if the source voltage is at a peak and the short-circuit nature of the power supply capacitors are sinking maximum current, the maximum current is less than the current that would cause a magnetic tripping of building branch-circuit protective devices (e.g., instantaneous trip).

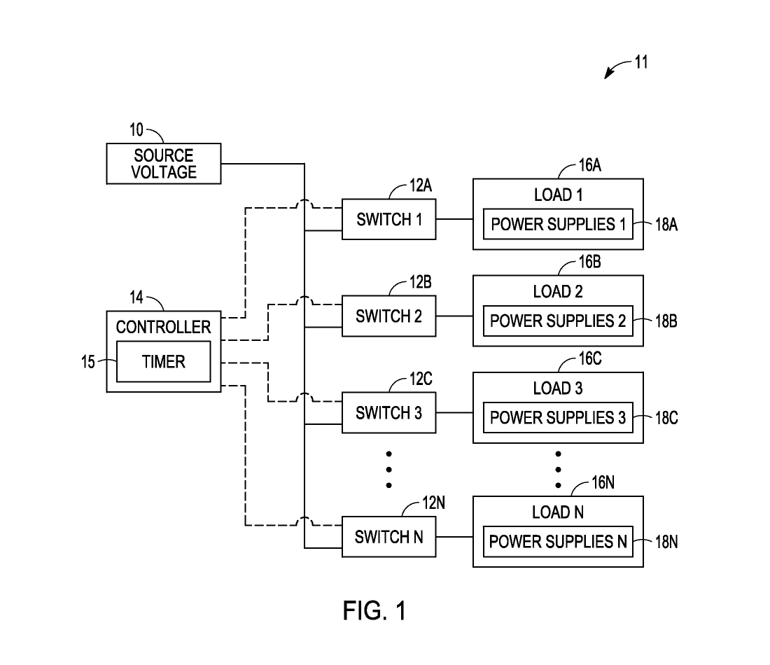

FIG. 1 is a block diagram of an example of system that can be used to control inrush current in a charging device configured to charge a plurality of electronic devices, in accordance with this disclosure. In FIG. 1, an AC source voltage 10 (or “common power source”) having a 50 Hz or 60 Hz input frequency is connected to a load management system, e.g., charging cart, desktop charger, and wall-mount charger, that is configured to charge a plurality of electronic devices. The system 11 can include a plurality of switches 12A-12N (collectively referred to in this disclosure as “switches 12”) and a controller 14 connected to each of the plurality of switches 12. The controller 14 can include a timer 15. The system includes an electrical power input (not depicted) configured to couple the system to the common power source.

Each switch 12 (or relay), e.g., an electro-mechanical or solid-state switch or relay, is connected to one or more electrical loads 16A-16N (collectively referred to in this disclosure as “loads 16”). Each load 16 can include one or more electronic devices, e.g., five computing devices. The one or more electronic devices in an electrical load 16 can include respective power supplies 18A-18N (collectively referred to in this disclosure as “power supplies 18”), which include one or more power supply capacitors. The controller 14 can supply a voltage to the power supplies 18 of the loads 16 by closing one or more of the switches 12.

When the source voltage 10 is first applied, the controller 14 can output a control signal to switch ON a first switch 12A connected to a first group of power supplies 18A having power supply capacitors and output a control signal to switch OFF any switches 12B-12N that may be ON. In this manner, the power supply capacitors of the power supplies 18A of the load 16A connected to the first switch 12A are allowed to charge for a specified period of time, or “a charging time,” using the timer 15. The charging time can vary. In some example implementations, the specified charging time, e.g., stored by controller 14, could be a short has a half-cycle which means, for example, eight groups of power supplies 18N with five power supplies per group (40 total power supplies) could be all charged in about 64 milliseconds to about 80 milliseconds depending on 50 Hertz or 60 Hertz operation (plus any switching latency). In other example implementations, the specified charging time can be one cycle. In another example implementation, the specified charging time can be about 100 milliseconds. In another example implementation, the specified charging time can be more than 100 milliseconds or less than 100 milliseconds.

When the controller 14 determines that the timer 15 has reached the specified charging time, the inrush current charging the power supply capacitors of the power supplies 18A of the load 16A will be considerably dampened or limited. Then, the controller 14 can output a control signal to switch ON another switch, e.g., the second switch 12B. In this manner, the power supply capacitors of the power supplies 18B of the load 16B can be connected to the second switch 12B and allowed to charge for the specified charging time.

When the controller 14 determines that the timer 15 has reached the specified charging time, the inrush current charging the power supply capacitors of the power supplies 18B of the load 16B will be considerably dampened or limited. Then, the controller 14 can output a control signal to switch ON another switch, e.g., the third switch 12C. In this manner, the power supply capacitors of the power supplies 18C of the load 16C can be connected to the third switch 12C and allowed to charge for the specified charging time.

The controller 14 can continue this pattern of turning ON a switch 12 and waiting for the timer 15 to reach the specified charging time before turning ON another switch 12 until the source voltage 10 has been applied to all groups of power supplies 18 during non-overlapping charging time periods, e.g., sequentially. This process can charge all the power supply input capacitors so that all power supplies 18 can then be powered on for a normal duration to do work.

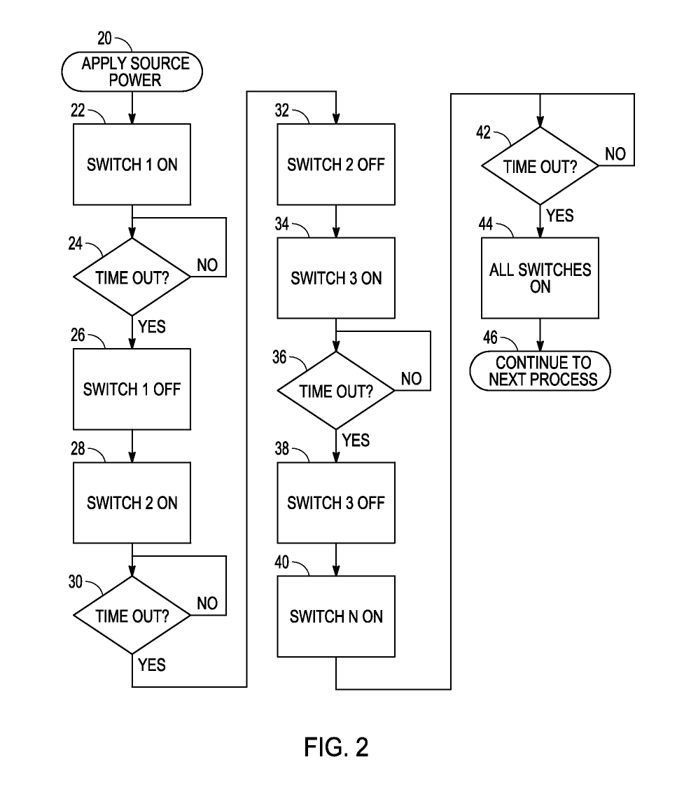

FIG. 2 is a flow diagram illustrating an example of a method of controlling inrush current in a charging device configured to charge a plurality of electronic devices, in accordance with this disclosure. A source voltage 10 is applied to the system 11 (block 20). The controller 14 can output a control signal to turn ON switch 1 (block 22), e.g., switch 12A (FIG. 1), thereby applying the source voltage to the power supplies 18A of the load 16A connected to switch 1, thereby charging the plurality of electronic devices of the load 16A.

The controller 14 can initiate/start and monitor a timer 15 corresponding to a stored specified charging time. If the timer 15 has not exceeded the charging time (“NO” branch of block 24), the controller continues to allow the switch 1 to remain ON and charge the power supplies 18A connected to the switch 1. If the timer 15 has exceeded the charging time (“YES” branch of block 24), the controller can output a control signal to turn OFF the switch 1 (block 26) and can output a control signal to turn ON the switch 2, e.g., switch 12B (FIG. 1) (block 28).

The controller 14 can initiate/start and monitor the timer 15 corresponding to the stored charging time. If the timer 15 has not exceeded the charging time (“NO” branch of block 30), the controller 14 can continue to allow the switch 2 to remain ON and charge the power supply capacitors connected to the switch 2. If the timer 15 has exceeded the charging time (“YES” branch of block 30), the controller 14 can output a control signal to turn OFF the switch 2 (block 32) and can output a control signal to turn ON the switch 3, e.g., switch 12C (FIG. 1) (block 34).

The controller 14 can initiate/start and monitor the timer 15 corresponding to the stored charging time. If the timer 15 has not exceeded the charging time (“NO” branch of block 36), the controller 14 can continue to allow the switch 3 to remain ON and charge the power supply capacitors connected to the switch 3. If the timer 15 has exceeded the charging time (“YES” branch of block 36), the controller 14 can output a control signal to turn OFF the switch 3 (block 38) and can output a control signal to turn ON the switch N, e.g., switch 12N (FIG. 1) (block 40).

The controller 14 can initiate/start and monitor the timer 15 corresponding to the stored charging time. If the timer 15 has not exceeded the charging time (“NO” branch of block 42), the controller 14 can continue to allow the switch N to remain ON and charge the power supply capacitors connected to the switch N. If the timer 15 has exceeded the charging time (“YES” branch of block 42), the controller 14 can output a control signal to turn ON all the switches 12, e.g., the switches 12A-12N (FIG. 1) (block 44) and then the controller can continue to a next step in the charging process now that the power supply capacitors are sufficiently charged. Thus, the controller 14 can sequentially turn on each of the plurality of switches and apply power from the common power source 10 to each of the plurality of electrical loads 16 during non-overlapping time periods, e.g., the specified charging time.

In some example implementations, a previous switch, e.g., switch 1, need not be turned OFF before the next switch, e.g., switch 2, is turned ON. For example, at block 26 in FIG. 2, rather than turning switch 1 OFF, the controller 14 can leave switch 1 ON since the inrush current into power supplies 18A of load 16A are considerably dampened or limited.

In this manner, potentially disruptive or damaging inrush current can be controlled by limiting the number of devices that are initially connected to the source voltage through the use of switches or relays. The techniques described in this disclosure can provide advantages over existing techniques. For example, the techniques of this disclosure do not need extra hardware for peak detection or zero-cross detection such as transformers, resistors, capacitors, MOSFETs, and any controlling firmware, thus saving cost, PCBA space, weight, size of device, and costs to the consumer. As another example, the techniques of this disclosure do not need large NTC devices and the associated thermal management, physical space, cost of components and ultimately cost to the consumer.

As another example, the techniques of this disclosure do not require changes to the building infrastructure with respect to branch circuit protection. The standard for circuit breaker trip time is described as type B, C, D and others. These trip type standards guarantee the minimum trip time and current. With the technique of small groups of power supplies being given a short duration of input voltage to charge their capacitors and then turning on the larger complete group of power supplies, as described above, the inrush currents are below the trip curves of these protection devices compared to all on at once which would result in a magnetic trip of the building breaker.

### Additional Notes

Example 1 includes or uses subject matter to charge a plurality of electronic devices (e.g., a system, apparatus, article, or the like) comprising: an electrical load management system configured to limit an inrush current, the system including: a plurality of switches coupled between a common alternating current power source and a plurality of electrical loads, each of the plurality of switches coupled to a respective one of the plurality of electrical loads, wherein each of the electrical loads includes one or more of the plurality of electronic devices; and a controller coupled to the plurality of switches, the controller configured to: sequentially turn on each of the plurality of switches and apply power from the common power source to each of the plurality of electrical loads during non-overlapping time periods to limit the inrush current.

In Example 2, the subject matter of Example 1, may optionally include, wherein each of the non-overlapping time periods is a specified charging time.

In Example 3, the subject matter of Example 2, may optionally include, wherein the specified charging time is based on a time to charge one or more power supply capacitors of the one or more power supplies of the respective one of the plurality of electrical loads.

In Example 4, the subject matter of any one or more of Examples 1-3 may optionally include, wherein each of the non-overlapping time periods is between about 10 milliseconds and about 100 milliseconds.

In Example 5, the subject matter of any one or more of Examples 1-4 may optionally include, wherein the controller configured to sequentially turn on each of the plurality of switches and apply power from the common power source to each of the plurality of electrical loads during non-overlapping time periods is configured to: output a control signal to turn on a first one of the plurality of switches and permit the power from the common power source to be applied to a first one of the plurality of electrical loads; start a timer; upon expiration of a first charging time by the timer, output a control signal to turn on a second one of the plurality of switches and permit the power from the common power source to be applied to a second one of the plurality of electrical loads; start the timer; upon expiration of a second charging time by the timer, output a control signal to turn on a third one of the plurality of switches and permit the power from the common power source to be applied to a third one of the plurality of electrical loads; repeat the outputting a control signal to one of the plurality of switches, the starting the timer, and the upon expiration of the charging time by the timer, outputting a control signal to another of the plurality of switches for each of the plurality of switches.

In Example 6, the subject matter of Example 5 may optionally include, wherein the controller is further configured to: upon expiration of the first charging time by the timer, output a control signal to turn off the first one of the plurality of switches; and upon expiration of the second charging time by the timer, output a control signal to turn off the second one of the plurality of switches.

In Example 7, the subject matter of any one or more of Examples 1-6 may optionally include, wherein the electrical load management system is configured to limit inrush current without using zero-crossing circuitry.

In Example 8, the subject matter of any one or more of Examples 1-6 may optionally include, wherein the electrical load management system is configured to limit inrush current without using peak voltage detection circuitry.

In Example 9, the subject matter of any one or more of Examples 1-6 may optionally include, wherein the electrical load management system is configured to limit an inrush current without using negative temperature coefficient circuitry.

In Example 10, the subject matter of any one or more of Examples 1-9 may optionally include, wherein the charging device configured to charge a plurality of electronic devices is selected from the group consisting of a charging cart, desktop charger, and wall-mount charger.

Example 11 includes subject matter for limiting inrush current while charging a plurality of electronic devices (such as a method, means for performing acts, machine readable medium including instructions that when performed by a machine cause the machine to performs acts, or an apparatus configured to perform), comprising: coupling a plurality of switches between a common alternating current power source and a plurality of electrical loads, each of the plurality of switches coupled to a respective one of the plurality of electrical loads, wherein each of the electrical loads includes one or more of the plurality of electronic devices; and sequentially turning on each of the plurality of switches and applying power from the common power source to each of the plurality of electrical loads during non-overlapping time periods to limit the inrush current.

In Example 12, the subject matter of Example 11 may optionally include, wherein each of the non-overlapping time periods is a specified charging time.

In Example 13, the subject matter of Example 12 may optionally include, wherein the specified charging time is based on a time to charge one or more power supply capacitors of the one or more power supplies of the respective one of the plurality of electrical loads.

In Example 14, the subject matter of any one or more of Examples 11-13 may optionally include, wherein each of the non-overlapping time periods is between about 10 milliseconds and about 100 milliseconds.

In Example 15, the subject matter of any one or more of Examples 11-14 may optionally include, sequentially turning on each of the plurality of switches and applying power from the common power source to each of the plurality of electrical loads during non-overlapping time periods includes: outputting a control signal to turn on a first one of the plurality of switches and permit the power from the common power source to be applied to a first one of the plurality of electrical loads; starting a timer; upon expiration of a first charging time by a timer, outputting a control signal to turn on a second one of the plurality of switches and permitting the power from the common power source to be applied to a second one of the plurality of electrical loads; starting the timer; upon expiration of a second charging time by the timer, outputting a control signal to turn on a third one of the plurality of switches and permitting the power from the common power source to be applied to a third one of the plurality of electrical loads; repeating the outputting a control signal to one of the plurality of switches, the starting the timer, and the upon expiration of the charging time by the timer, outputting a control signal to another of the plurality of switches for each of the plurality of switches.

In Example 16, the subject matter of Example 15 may optionally include, upon expiration of the first charging time by the timer, outputting a control signal to turn off the first one of the plurality of switches; and upon expiration of the second charging time by the timer, outputting a control signal to turn off the second one of the plurality of switches.

In Example 17, the subject matter of any one or more of Examples 11-16 may optionally include, wherein the inrush current limited by the method is limited without using zero-crossing detection.

In Example 18, the subject matter of any one or more of Examples 11-16 may optionally include, wherein the inrush current limited by the method is limited without using peak voltage detection.

In Example 19, the subject matter of any one or more of Examples 11-16 may optionally include, wherein the inrush current limited by the method is limited without using negative temperature coefficient techniques.

Example 20 includes or uses subject matter to charge a plurality of electronic devices (e.g., a system, apparatus, article, or the like) comprising: an electrical load management system configured to limit an inrush current, the system including: a plurality of switches coupled between a common alternating current power source and a plurality of electrical loads, each of the plurality of switches coupled to a respective one of the plurality of electrical loads, wherein each of the electrical loads includes one or more of the plurality of electronic devices; and a controller coupled to the plurality of switches, the controller configured to: output a control signal to turn on a first one of the plurality of switches and permit the power from the common power source to be applied to a first one of the plurality of electrical loads; start a charging timer; output a control signal to turn off the first one of the plurality of switches upon expiration of the charging timer; output a control signal to turn on a second one of the plurality of switches and permit the power from the common power source to be applied to a second one of the plurality of electrical loads; start the charging timer; output a control signal to turn off the second one of the plurality of switches upon expiration of the charging timer; and repeat the outputting a control signal to one of the plurality of switches, the starting the timer, and the upon expiration of the charging time by the timer, outputting a control signal to another of the plurality of switches for each of the plurality of switches.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A charging device configured to charge a plurality of electronic devices, the charging device comprising:
an electrical load management system configured to limit an inrush current, the system including:
a plurality of switches coupled between a common alternating current power source and a plurality of electrical loads, each of the plurality of switches coupled to a respective one of the plurality of electrical loads, wherein each of the electrical loads includes one or more of the plurality of electronic devices; and
a controller coupled to the plurality of switches, the controller configured to:
sequentially turn on each of the plurality of switches and apply power from the common power source to each of the plurality of electrical loads during non-overlapping time periods to limit the inrush current.

2. The charging device of claim 1, wherein each of the on-overlapping time periods is a specified charging time.

3. The charging device of claim 2, wherein the specified charging time is based on a time to charge one or more power supply capacitors of the one or more power supplies of the respective one of the plurality of electrical loads.

4. The charging device of claim 1, wherein each of the non-overlapping time periods is between about 10 milliseconds and about 100 milliseconds.

5. The charging device of claim 1, wherein the controller configured to sequentially turn on each of the plurality of switches and apply power from the common power source to each of the plurality of electrical loads during non-overlapping time periods is configured to:
output a control signal to turn on a first one of the plurality of switches and permit the power from the common power source to be applied to a first one of the plurality of electrical loads;
start a timer;
upon expiration of a first charging time by the timer, output a control signal to turn on a second one of the plurality of switches and permit the power from the common power source to be applied to a second one of the plurality of electrical loads;
start the timer;
upon expiration of a second charging time by the timer, output a control signal to turn on a third one of the plurality of switches and permit the power from the common power source to be applied to a third one of the plurality of electrical loads;
repeat the outputting a control signal to one of the plurality of switches, the starting the timer, and the upon expiration of the charging time by the timer, outputting a control signal to another of the plurality of switches for each of the plurality of switches.

6. The charging device of claim 5, wherein the controller is further configured to:
upon expiration of the first charging time by the timer, output a control signal to turn off the first one of the plurality of switches; and
upon expiration of the second charging time by the timer, output a control signal to turn off the second one of the plurality of switches.

7. The charging device of claim 1, wherein the electrical load management system is configured to limit inrush current without using zero-crossing circuitry.

8. The charging device of claim 1, wherein the electrical load management system is configured to limit inrush current without using peak voltage detection circuitry.

9. The charging device of claim 1, wherein the electrical load management system is configured to limit an inrush current without using negative temperature coefficient circuitry.

10. The charging device of claim 1, wherein the charging device configured to charge a plurality of electronic devices is selected from the group consisting of a charging cart, desktop charger, and wall-mount charger.

11. A method of limiting inrush current while charging a plurality of electronic devices, the method comprising:
coupling a plurality of switches between a common alternating current power source and a plurality of electrical loads, each of the plurality of switches coupled to a respective one of the plurality of electrical loads, wherein each of the electrical loads includes one or more of the plurality of electronic devices; and
sequentially turning on each of the plurality of switches and applying power from the common power source to each of the plurality of electrical loads during non-overlapping time periods to limit the inrush current.

12. The method of claim 11, wherein each of the non-overlapping time periods is a specified charging time.

13. The method of claim 12, wherein the specified charging time is based on a time to charge one or more power supply capacitors of the one or more power supplies of the respective one of the plurality of electrical loads.

14. The method of claim 11, wherein each of the non-overlapping time periods is between about 10 milliseconds and about 100 milliseconds.

15. The method of claim 11, wherein sequentially turning on each of the plurality of switches and applying power from the common power source to each of the plurality of electrical loads during non-overlapping time periods includes:
outputting a control signal to turn on a first one of the plurality of switches and permit the power from the common power source to be applied to a first one of the plurality of electrical loads;
starting a timer;
upon expiration of a first charging time by a timer, outputting a control signal to turn on a second one of the plurality of switches and permitting the power from the common power source to be applied to a second one of the plurality of electrical loads;
starting the timer;
upon expiration of a second charging time by the timer, outputting a control signal to turn on a third one of the plurality of switches and permitting the power from the common power source to be applied to a third one of the plurality of electrical loads;
repeating the outputting a control signal to one of the plurality of switches, the starting the timer, and the upon expiration of the charging time by the timer, outputting a control signal to another of the plurality of switches for each of the plurality of switches.

16. The method of claim 15, further comprising:
upon expiration of the first charging time by the timer, outputting a control signal to turn off the first one of the plurality of switches; and
upon expiration of the second charging time by the timer, outputting a control signal to turn off the second one of the plurality of switches.

17. The method of claim 11, wherein the inrush current limited by the method is limited without using zero-crossing detection.

18. The method of claim 11, wherein the inrush current limited by the method is limited without using peak voltage detection.

19. The method of claim 11, wherein the inrush current limited by the method is limited without using negative temperature coefficient techniques.

20. A charging device configured to charge a plurality of electronic devices, the charging device comprising:
an electrical load management system configured to limit an inrush current, the system including:
a plurality of switches coupled between a common alternating current power source and a plurality of electrical loads, each of the plurality of switches coupled to a respective one of the plurality of electrical loads, wherein each of the electrical loads includes one or more of the plurality of electronic devices; and
a controller coupled to the plurality of switches, the controller configured to:
output a control signal to turn on a first one of the plurality of switches and permit the power from the common power source to be applied to a first one of the plurality of electrical loads;
start a charging timer;
output a control signal to turn off the first one of the plurality of switches upon expiration of the charging timer;
output a control signal to turn on a second one of the plurality of switches and permit the power from the common power source to be applied to a second one of the plurality of electrical loads;
start the charging timer;
output a control signal to turn off the second one of the plurality of switches upon expiration of the charging timer; and
repeat the outputting a control signal to one of the plurality of switches, the starting the timer, and the upon expiration of the charging time by the timer, outputting a control signal to another of the plurality of switches for each of the plurality of switches.
